(19) United States
(12) Patent Application Publication
(10) Pub. No.: US 2014/0152823 A1
(43) Pub. Date: Jun. 5, 2014

(54) Techniques to Obtain Information About Objects Around a Vehicle

(71) Applicant: American Vehicular Sciences LLC, (US)

(72) Inventor: David S. Breed, Miami Beach, FL (US)

(73) Assignee: AMERICAN VEHICULAR SCIENCES LLC, Frisco, TX (US)

(21) Appl. No.: 13/849,715

(22) Filed: Mar. 25, 2013

Related U.S. Application Data
(63) Continuation-in-part of application No. 13/185,770, filed on Jul. 19, 2011, now abandoned.
Application No. 13/185,770 is a division of application No. 11/025,501, filed on Jan. 3, 2005, now Pat. No. 7,983,817.
Application No. 11/025,501 is a continuation-in-part of application No. 10/116,808, filed on Apr. 5, 2002, now Pat. No. 6,856,873.
Application No. 10/116,808 is a continuation-in-part of application No. 09/838,919, filed on Apr. 20, 2001, now Pat. No. 6,442,465.
Application No. 09/838,919 is a continuation-in-part of application No. 09/765,559, filed on Jan. 19, 2001, now Pat. No. 6,553,296.
Application No. 09/765,559 is a continuation-in-part of application No. 09/476,255, filed on Dec. 30, 1999, now Pat. No. 6,324,453.
Application No. 09/838,919 is a continuation-in-part of application No. 09/389,947, filed on Sep. 3, 1999, now Pat. No. 6,393,133.
Application No. 09/389,947 is a continuation-in-part of application No. 09/200,614, filed on Nov. 30, 1998, now Pat. No. 6,141,432.
Application No. 10/116,808 is a continuation-in-part of application No. 09/925,043, filed on Aug. 8, 2001, now Pat. No. 6,507,779.
Application No. 09/925,043 is a continuation-in-part of application No. 09/765,559, filed on Jan. 19, 2001, now Pat. No. 6,553,296.
Application No. 09/765,559 is a continuation-in-part of application No. 09/389,947, filed on Sep. 3, 1999, now Pat. No. 6,393,133.
Application No. 11/025,501 is a continuation-in-part of application No. 10/413,426, filed on Apr. 14, 2003, now Pat. No. 7,415,126.
Application No. 10/413,426 is a continuation-in-part of application No. 10/302,105, filed on Nov. 22, 2002, now Pat. No. 6,772,057.
Application No. 10/302,105 is a continuation-in-part of application No. 10/116,808, filed on Apr. 5, 2002, now Pat. No. 6,856,873.
Application No. 11/025,501 is a continuation-in-part of application No. 10/931,288, filed on Aug. 31, 2004, now Pat. No. 7,164,117.
Application No. 10/931,288 is a continuation-in-part of application No. 10/940,881, filed on Sep. 13, 2004, now Pat. No. 7,663,502.
(60) Provisional application No. 60/114,507, filed on Dec. 31, 1998.

(51) Int. Cl. H04N 7/18

(52) U.S. Cl. CPC H04N 7/18
USPC 348/148

(57) ABSTRACT

Method for monitoring an area surrounding a host vehicle or objects external of the vehicle includes projecting light into an area of interest external to the vehicle from one or more light sources on the vehicle, detecting reflected light at at least one camera on the vehicle at a position different than the position from which the light is projected and at a position from which light reflected from any objects in the area of interest in the exterior of the vehicle is received and analyzing the reflected light relative to the projected light to obtain information about a distance between the vehicle and objects located in the area of interest and/or motion of the objects located in the area of interest. Then, one or more actions are undertaken on the vehicle based on the information about the distance and motion of the external object.

### CROSS REFERENCE TO RELATED APPLICATIONS

This application is continuation-in-part of U.S. patent application Ser. No. 13/185,770 filed Jul. 19, 2011 which is a divisional of U.S. patent application Ser. No. 11/025,501 filed Jan. 3, 2005, now U.S. Pat. No. 7,983,817, which is:
1. a continuation-in-part of U.S. patent application Ser. No. 10/116,808 filed Apr. 5, 2002, now U.S. Pat. No. 6,856,873, which is:
   a. a continuation-in-part of U.S. patent application Ser. No. 09/838,919 filed Apr. 20, 2001, now U.S. Pat. No. 6,442,465, which is:
      1) a continuation-in-part of U.S. patent application Ser. No. 09/765,559 filed Jan. 19, 2001, now U.S. Pat. No. 6,553,296, which is a continuation-in-part of U.S. patent application Ser. No. 09/476,255 filed Dec. 30, 1999, now U.S. Pat. No. 6,324,453, which claims priority under 35 U.S.C. §119(e) of U.S. provisional patent application Ser. No. 60/114,507 filed Dec. 31, 1998, now expired; and
      2) a continuation-in-part of U.S. patent application Ser. No. 09/389,947 filed Sep. 3, 1999, now U.S. Pat. No. 6,393,133, which is a continuation-in-part of U.S. patent application Ser. No. 09/200,614, filed Nov. 30, 1998, now U.S. Pat. No. 6,141,432;
   b. a continuation-in-part of U.S. patent application Ser. No. 09/925,043 filed Aug. 8, 2001, now U.S. Pat. No. 6,507,779, which is a continuation-in-part of U.S. patent application Ser. No. 09/765,559 filed Jan. 19, 2001, now U.S. Pat. No. 6,553,296, and a continuation-in-part of U.S. patent application Ser. No. 09/389,947 filed Sep. 3, 1999, now U.S. Pat. No. 6,393,133;
2. a continuation-in-part of U.S. patent application Ser. No. 10/413,426 filed Apr. 14, 2003, now U.S. Pat. No. 7,415,126, which is a continuation-in-part of U.S. patent application Ser. No. 10/302,105 filed Nov. 22, 2002, now U.S. Pat. No. 6,772,057, which is a continuation-in-part of U.S. patent application Ser. No. 10/116,808 filed Apr. 5, 2002, now U.S. Pat. No. 6,856,873, the history of which is set forth above;
3. a continuation-in-part of U.S. patent application Ser. No. 10/931,288 filed Aug. 31, 2004, now U.S. Pat. No. 7,164,117; and
4. a continuation-in-part of U.S. patent application Ser. No. 10/940,881 filed Sep. 13, 2004, now U.S. Pat. No. 7,663,502.

All of the above-referenced applications are incorporated by reference herein.

### FIELD OF THE INVENTION

The present invention relates generally to methods and arrangements for obtaining information about objects exterior of a vehicle, which information may be used for controlling a vehicular system, subsystem or component. More particularly, the present invention relates to technique to obtain information about a distance between an object and a host vehicle and the velocity or speed of the object relative to the host vehicle. Using distance and speed information, it is possible to activate a reactive or responsive system on the host vehicle to reduce the likelihood of a collision between the object and the host vehicle.

### BACKGROUND OF THE INVENTION

Background of the invention is set forth in the parent application, U.S. patent application Ser. No. 11/025,501, along with definitions of terms used herein, all of which is incorporated by reference herein. Further, all of the patents, patent applications, technical papers and other references mentioned below are incorporated herein by reference in their entirety unless stated otherwise. In additional, extensive disclosure of vehicle occupant sensing is found in U.S. patent application Ser. No. 10/940,881, incorporated by reference herein.

### SUMMARY OF THE INVENTION

Method for monitoring an area surrounding a host vehicle or objects external of the host vehicle during movement of the host vehicle under control of an occupant in the host vehicle, when the host vehicle has a frame defining a compartment that accommodates the occupant of the host vehicle who is able to guide movement of the host vehicle when present in the compartment. The method includes projecting light into an area of interest external to the host vehicle from a light source on the host vehicle, detecting reflected light at at least one camera arranged on the host vehicle at a position different than the position from which the light is projected and at a position from which light reflected from any objects in the area of interest in the exterior of the host vehicle is received and analyzing the reflected light relative to the projected light to obtain information about a distance between the host vehicle and objects located in the area of interest and/or motion of the objects located in the area of interest. Then, one or more actions are undertaken on the vehicle based on the information about the distance and motion of the external object.

### BRIEF DESCRIPTION OF THE DRAWINGS

The following drawings are illustrative of embodiments of the system developed or adapted using the teachings of at least one of the inventions disclosed herein and are not meant to limit the scope of the invention as encompassed by the claims. In particular, the illustrations below are frequently limited to the monitoring of the front passenger seat for the purpose of describing the system. Naturally, the invention applies as well to adapting the system to the other seating positions in the vehicle and particularly to the driver and rear passenger positions.

FIG. 1 is a schematic of a method in accordance with the invention using structured light.

FIG. 2 is a schematic of an arrangement in accordance with the invention using structured light.

FIG. 3 is a diagram showing a host vehicle that applies the structured light exterior monitoring technique in accordance with the invention.

FIG. 4 shows a camera system used in the invention.

### DETAILED DESCRIPTION OF THE PREFERRED EMBODIMENTS

The following description is based in part on disclosure in U.S. patent application Ser. No. 13/185,770, incorporated by reference herein.

In the vehicular monitoring techniques disclosed in the '770 application, a source and receiver of electromagnetic radiation have frequently been mounted in the same package. This is co-location not necessary and in some implementations, the illumination source will be mounted elsewhere. For example, a laser beam can be used which is directed along an axis which bisects the angle between the center of the seat volume, or other volume of interest, and two of the arrays. Such a beam may come from the A-Pillar, for example. The beam, which may be supplemental to the main illumination system, provides a point reflection from the occupying item that, in most cases, can be seen by two receivers, even if they are significantly separated from each other, making it easier to identify corresponding parts in the two images. Triangulation thereafter can precisely determine the location of the illuminated point. This point can be moved, or a pattern of points provided, to provide even more information. In another case where it is desired to track the head of the occupant, for example, several such beams can be directed at the occupant's head during pre-crash braking or even during a crash to provide the fastest information as to the location of the head of the occupant for the fastest tracking of the motion of the occupant's head. Since only a few pixels are involved, even the calculation time is minimized.

In most of the applications in the '770 application, the assumption has been made that either a uniform field of light or a scanning spot of light will be provided. This need not be the case. The light that is emitted or transmitted to illuminate the object can be, but is not required to be, structured light. Structured light can take many forms starting with, for example, a rectangular or other macroscopic pattern of light and dark that can be superimposed on the light by passing it through a filter. If a similar pattern is interposed between the reflections and the camera, a sort of pseudo-interference pattern can result sometimes known as Moiré patterns. A similar effect can be achieved by polarizing transmitted light so that different parts of the object that is being illuminated are illuminated with light of different polarization. Once again, by viewing the reflections through a similarly polarized array, information can be obtained as to where the source of light came from which is illuminating a particular object. Any of the transmitter/receiver assemblies or transducers in any of the embodiments above using optics can be designed to use structured light.

Usually the source of the structured light is displaced vertically, laterally or axially from the imager, but this need not necessarily be the case. One excellent example of the use of structured light to determine a 3D image where the source of the structured light and the imager are on the same axis is illustrated in U.S. Pat. No. 5,003,166, incorporated by reference herein. Here, the third dimension is obtained by measuring the degree of blur of the pattern as reflected from the object. This can be done since the focal point of the structured light is different from the camera. This is accomplished by projecting it through its own lens system and then combining the two paths through the use of a beam splitter. The use of this or any other form of structured light is within the scope of at least one of the inventions disclosed herein. There are so many methods that the details of all of them cannot be enumerated here.

One consideration when using structured light is that the source of structured light should not generally be exactly co-located with the array because in this case, the pattern projected will not change as a function of the distance between the array and the object and thus the distance between the array and the object cannot be determined, except by the out-of-focus and similar methods discussed above. Thus, it is usually necessary to provide a displacement between the array and the light source. For example, the light source can surround the array, be on top of the array or on one side of the array. The light source can also have a different virtual source, i.e., it can appear to come from behind of the array or in front of the array, a variation of the out-of-focus method discussed above.

For a laterally displaced source of structured light, the goal is to determine the direction that a particular ray of light had when it was transmitted from the source. Then, by knowing which pixels were illuminated by the reflected light ray along with the geometry of the vehicle, the distance to the point of reflection off of the object can be determined. Successive distance measurements between the host vehicle and the same object provide information about motion of the object relative to the host vehicle. If a particular light ray, for example, illuminates an object surface which is near to the source, then the reflection off of that surface will illuminate a pixel at a particular point on the imaging array. If the reflection of the same ray however occurs from a more distant surface, then a different pixel will be illuminated in the imaging array. In this manner, the distance from the surface of the object to the array can be determined by triangulation formulas. Similarly, if a given pixel is illuminated in the imager from a reflection of a particular ray of light from the transmitter, and knowing the direction that that ray of light was sent from the transmitter, then the distance to the object at the point of reflection can be determined. If each ray of light is individually recognizable and therefore can be correlated to the angle at which it was transmitted, a full three-dimensional image can be obtained of the object that simplifies the identification problem. This can be done with a single imager.

One particularly interesting implementation due to its low cost is to project one or more dots or other simple shapes onto the occupant from a light source at a position which is at an angle relative to the occupant such as 10 to 45 degrees from the camera location. These dots will show up as bright spots even in bright sunlight and their location on the image obtained by the camera will permit the position of the occupant to be determined. Since the parts of the occupant are all connected with relative accuracy, the position of the occupant can now be accurately determined using, at a minimum, only one simple camera. Additionally, the light that makes up the dots can be modulated and the distance from the dot source can then be determined if there is a receiver at the light source and appropriate circuitry such as used with a scanning range meter.

The coding of the light rays coming from the transmitter can be accomplished in many ways. One method is to polarize the light by passing the light through a filter whereby the polarization is a combination of the amount and angle of the polarization. This gives two dimensions that can therefore be used to fix the angle that the light was sent. Another method is to superimpose an analog or digital signal onto the light which could be done, for example, by using an addressable light valve, such as a liquid crystal filter, electrochromic filter, or, preferably, a garnet crystal array. Each pixel in this array would be coded such that it could be identified at the imager or other receiving device. Any of the modulation schemes could be applied such as frequency, phase, amplitude, pulse, random or code modulation.

The techniques described above can depend upon either changing the polarization or using the time, spatial or frequency domains to identify particular transmission angles with particular reflections. Spatial patterns can be imposed on the transmitted light which generally goes under the heading of structured light. The concept is that if a pattern is identifiable, then either the direction of transmitted light can be determined or, if the transmission source is co-linear with the receiver, then the pattern differentially expands or contracts relative to the field of view as it travels toward the object and then, by determining the size or focus of the received pattern, the distance to the object can be determined. In some cases, Moiré pattern techniques are utilized.

When the illumination source is not placed on the same axis as the receiving array, it is typically placed at an angle such as 45 degrees. At least two other techniques can be considered. One is to place the illumination source at 90 degrees to the imager array. In this case, only those surface elements that are closer to the receiving array than previous surfaces are illuminated.

Thus, significant information can be obtained as to the profile of the object. In fact, if no object is occupying the seat, then there will be no reflections except from the seat itself. This provides a very powerful technique for determining whether the seat is occupied and where the initial surfaces of the occupying item are located. A combination of the above techniques can be used with temporally or spatially varying illumination. Taking images with the same imager but with illumination from different directions can also greatly enhance the ability to obtain three-dimensional information.

The particular radiation field of the transmitting transducer can also be important to some implementations of at least one of the inventions disclosed herein. In some techniques, the object which is occupying the seat is the only part of the vehicle which is illuminated. Extreme care is exercised in shaping the field of light such that this is true. For example, the objects are illuminated in such a way that reflections from the door panel do not occur. Ideally, if only the items which occupy the seat can be illuminated, then the problem of separating the occupant from the interior vehicle passenger compartment surfaces can be more easily accomplished. Sending illumination from both sides of the vehicle across the vehicle can accomplish this.

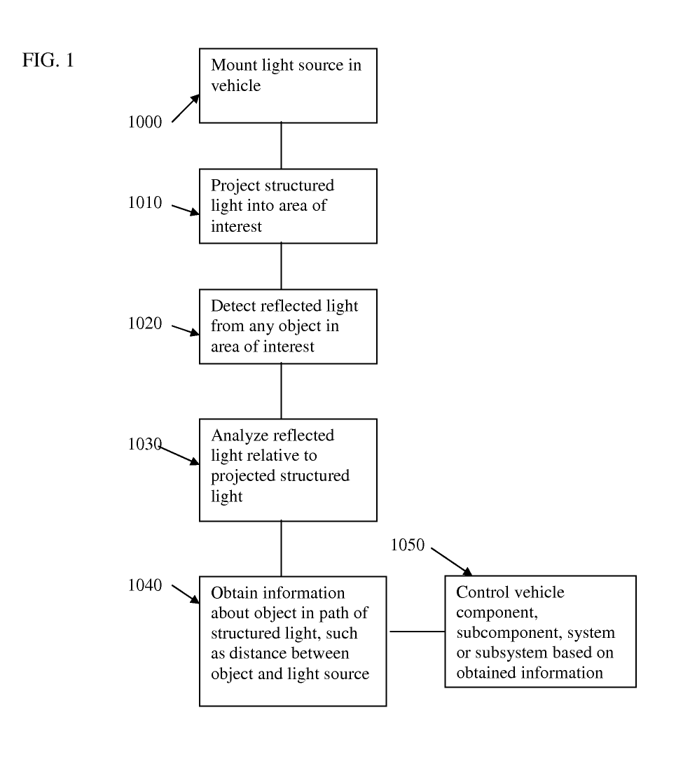

To summarize the use of structured light to obtain information about a vehicle occupant in a compartment of the vehicle, FIG. 1 shows a schematic of a method using structured light. At step 1000, a light source is mounted in the vehicle, for example, in the dashboard, instrument panel or ceiling of the vehicle. Multiple light sources can be used. At step 1010, structured light is projected into an area of interest in the compartment, the rays of light forming the structured light originating from the light source. At step 1020, light reflected from any objects in the path of the projected structured light is received by an image sensor or imager and at step 1030, the received reflected light is analyzed relative to the projected structured light, e.g., by a processor or control module or unit, to obtain information about the object(s) (step 1040). Such information can be the distance between the object and the light source, the location from which the structured light is projected, and/or the image sensor. Sequential distance information, i.e., information about the same object obtained from time-spaced images, can be used to analyze motion of the object. This information is used to control one or more vehicle components, subcomponents, systems or subsystems (step 1050).

Variations to the method include imposing a pattern in the structured light, such as pattern of dots or lines, and arranging the image sensor at a different location in the vehicle than the light source such that the location from which structured light is projected is spaced apart from the image sensor. For example, the image sensor can be arranged relative to the light source such that a line between the image sensor and the area of interest is at an angle of about 20° to about 45° to a line between the location from which the structured light is projected and the area of interest. The light pattern of structured light can be varied or modified to create a virtual light source different than the light source. This may be achieved by interposing a first filter in front of the actual light source, in which case, a second filter similar to the first filter is arranged between the area of interest and the image sensor. The structured light can also be formed by polarizing the rays of light from the light source so that different parts of the area of interest are illuminated with light having different polarization, or by imposing spatial patterns on the rays of light from the light source such that the time domain is used to identify particular transmission angles with particular reflections.

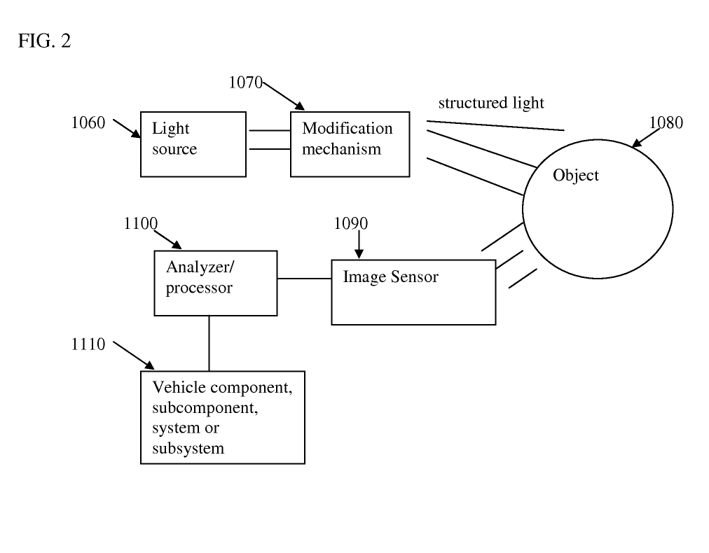

FIG. 2 is a schematic of an arrangement for obtaining information about objects in a compartment of a vehicle summarizing the discussion herein. The arrangement includes a light source 1060, a modification mechanism 1070 for projecting structured light generated from the rays of light from the light source, and an image sensor 1080 which receives light reflected from the object 1070. An analyzer/processor 1090 is used to analyze the received reflected light relative to the projected structured light to obtain information about the object 1070. This information, i.e., distance, motion and/or identification, is used in the control of one or more vehicle components, subcomponents, systems or subsystems. The modification mechanism may be designed to modify rays of light generated by the light source to cause the projection of structured light into the area of interest in the compartment. A filter is one example of a modification mechanism, and if used, a similar filter is arranged between the area of interest and the image sensor.

The modification mechanism can also be a mechanism which polarizes the rays of light from the light source so that different parts of the area of interest are illuminated with light having different polarization, or which imposes spatial patterns on the rays of light from the light source such that the time domain is used to identify particular transmission angles with particular reflections.

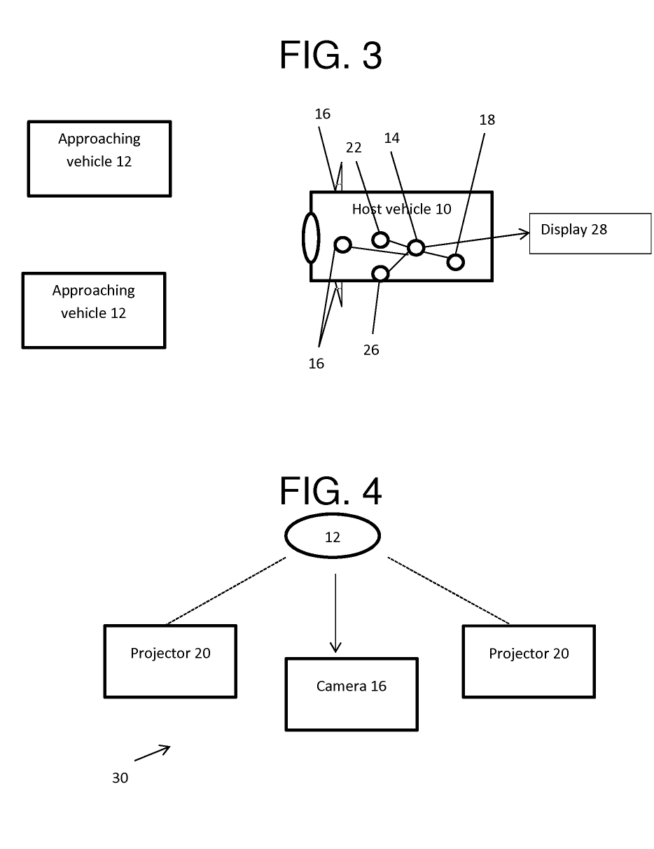

Referring now to FIG. 3, one of the primary purposes of structured light is to determine the distance and relative motion from the host vehicle 10 to an approaching object 12, as explained above. However, there are various alternative ways to determine this distance and relative motion, some of which do not require structured light to be projected from the light source(s) on the vehicle.

One way that may be implemented in a processor 14 on the host vehicle 10 is to draw in an image obtained from one of the cameras 16 on the vehicle, a box around a front or some portion of the oncoming object, i.e., a pair of spaced apart vertical edges that connect to a pair of spaced apart horizontal edges, or use a different combination of vertical and horizontal edges. The presence of an object in an obtained image may be determined in any manner known to those skilled in the art, e.g., edge detection, and processor 14 configured accordingly. A computer program may be executed by the processor 14 to perform image processing in the following manner, or the processor 14 may be otherwise configured to effect the following steps.

If a vertical edge of the box around a vehicle in images is moving sideways as determined from sequential analysis of the reflected light in multiple images obtained by the camera 16 and the height (difference between two horizontal edges) is not changing, the processor 14 would output that the vehicle is moving to a side. Taking the ratio of the sideways movement to the growth gives the motion vector. This computation can also be performed in or by the processor 14. More generally, virtual positioning of one or more lines on an image relative to an object such as a vehicle in the image can be used to track movement of the virtual line(s) relative to the object to assess motion of the object relative to the host vehicle on which the camera is mounted.

The physical location of each camera 16 on the host vehicle 10 is an important design point to facilitate the image techniques disclosed herein. Generally, one camera 16 is positioned as an outward looking camera attached to a rear view mirror, either one inside the vehicle or one outside of the vehicle. Each rear view minor may include such a camera 16. Another camera may be attached to the windshield in the vicinity of the rear view minor. Also, as shown in FIG. 36 of the '770 application, a camera looking sideways from the host vehicle 10 may also be provided.

A monitoring arrangement in accordance with the invention may therefore include multiple cameras that observe the entire environment or an area of interest around the host vehicle 10. The processor 14 may be connected to these cameras 16 and configured to control a display 28 to display an overhead or birds eye view. Image processing techniques disclosed in “STMicroelectronics Shows Unique Metal Alloys Improving Cameraphone Pictures for Optical Image Stabilization (OIS)”, prnewswire.com, Feb. 23, 2012 may be incorporated into the invention.

Since each camera 16 is preferably rigidly attached to the host vehicle 10, a single IMU 22, perhaps centrally located on the host vehicle 10, can be used for optical image stabilization (OIS) since with the knowledge of the relative camera location to the IMU 22, it is possible for the processor 14 to calculate the motion at the camera 16 based on the motion at the IMU 22. An IMU is an inertial measurement unit that provides one or more inertial measurements of the vehicle, e.g., acceleration in three orthogonal directions and angular motion in three orthogonal directions.

Another way to derive information from an image obtained by a camera 16 is to add information from a map obtained from a map database 18, such as road shape including for example altitude change, curvature, to be input to the processor 14 to enable the processor 14 to determine the distance to the object (e.g., on a flat road, the amount of road seen in the image tells how far away the object is which can be corrected if the map contains altitude information). Similarly, use of the lane width or another object of known size in the map from the map database 18 allows the size of the object to be ratioed, etc. In this technique, an image derived from the reflected light received by camera 16 is input into the processor 14, which is also provided with map data about roads or other geographic features in the image from the map database 18. Then, the distance between the host vehicle 10 and an object in the image is determined based on the map data.

Additional information about the manner in which the processor 14 is configured to provide for this functionality is set forth in “Depth estimation and occlusion boundary recovery from a single outdoor image”, by Shihui Zhang and Shuo Yan, Opt. Eng. 51, 087003 (2012), and 1394 cameras: Simple designs with high bandwidth, low latency, scalability, by Richard Mourn, Mar. 15, 2010, both of which are incorporated by reference herein.

Yet another way to derive information from an image obtained by a camera 16 is to use aspheric lens and Fish eye lens in the camera 16 that allow for distance measurements. In this regard, reference is made to “Point Grey Launches New Ladybug5 Spherical Imaging System, Offers 30 MP Resolution and 360-Degree Video Streaming”, Jan. 30, 2013—Richmond, BC, Canada; “Equidistant Fish-Eye Calibration and Rectification by Vanishing Point Extraction”, IEEE transactions on Pattern Analysis and Machine Intelligence, December 2010 (vol. 32 no. 12) pp. 2289-2296; “Researchers develop genuine 3D camera”, by Paul Ridden, gizmag.com, Dec. 7, 2010; “Dot panoramic lens shoots 360-degree iPhone videos”, by Ben Coxworth, gizmag.com, Jun. 16, 2011; and “CES setting up its own startup alley”, cnet.com, by Daniel Terdiman, Dec. 20, 2011, all of which are incorporated by reference herein.

A particularly important development contemplated for application in the invention is use of any one of a number of special cameras that measure angle of light at each pixel. Such cameras are not believed to be currently used to measure distance to an object but rather only for focusing. However, a processor 14 may be configured to control such a special camera to perform the focusing and monitoring the focusing activity. Knowing what adjustments are needed to bring a particular object into focus enables the processor 14 to calculate the distance to that object. Relevant literature about such special cameras that may be applied in the invention include: “Lytro light field camera lets users adjust a photo's focus after it's been taken”, by Ben Coxworth, gizmag.com, Jun. 22, 2011; “Lytro light field camera unveiled, shipping 2012”, by Ben Coxworth, gizmag.com, Oct. 19, 2011; “Toshiba smartphone camera sensor has eye on future”, by Nancy Owano, phys.org, Dec. 28, 2012; and “Toshiba Develops Lytro-Like Smartphone Camera Sensor”, by Tyler Lee, ubergizmo, com on Dec. 27, 2012, all of which are incorporated by reference herein.

The foregoing techniques relate in part to the processing of the light received by the cameras 16, i.e., the reflection of light projected from a light source. This processing may be performed internal to the processor 14 or internal to each camera 16.

Referring now to FIG. 4, in an embodiment of a camera system 30 in accordance with the invention, a specific dot pattern is projected, namely, two dots at a fixed spacing. When two dots are projected from the sides of the host vehicle 10, i.e., from light projectors or illuminators 20 as shown in FIG. 4, and a camera 16 is in between the projectors 20, then the distance to an object can be easily determined by the spacing of the reflected dots which will change as the reflecting object approaches. The projections can be parallel to one another or at known angles, i.e., light beams that intersect one another.

It is also possible to add an array of laser dots for determining velocity (as in lidar but with or without moving the dots) and use the camera to determine which one corresponds with which object. This would be a relatively simple way to get the relative velocities of all objects in the field of view of the camera. More specifically, an illuminator can be configured to generate and project an array of laser dots, or any other structure capable of generating an array of laser dots can alternatively be used, wherein each dot has a recognizable signature such as the way in which it is polarized, its color (frequency), the modulation code and/or frequency. These are examples of many techniques which can be used to render each dot distinguishable. Once the reflection of a dot is received by one or more pixels of an imager or camera, it can be distinguished from all other dots, with knowledge of the recognizable signature for the projection of each dot, and the distance to the object and thus its velocity can be determined by the techniques mentioned herein, such as range gating or phase analysis.

An arrangement to implement this embodiment may include a system that generates an array of laser dots and is capable of imparting a unique property to each dot, such as a unique polarity. The arrangement would also include a light receiver or imager that receives reflections of the dot or dots from one or more objects, and a processor coupled to the light receiver or imager and that processes data about the received dot into an indication of a distance and/or velocity between the imager/receiver, which may be co-located on a vehicle, and the object by accessing stored information about the properties of the dots. The processor might access a storage device that stores the information about the dots, and based on the property or properties of the received dot, retrieve the projection information about that dot from the storage device. Analysis of the projection information and the reception information can result in the distance and/or velocity information.

Additionally or alternatively, it is possible to add colored light and polarized light. This aspect is disclosed in, for example, “Determining Both Surface Position and Orientation in Structured-Light-Based Sensing”, IEEE Transactions on Pattern Analysis and Machine Intelligence, vol. 32, no. 10, pp. 1770-1780, October, 2010.

A technique disclosed in “3D Models Created by a Cell Phone”, technologyreview.com, by Tom Simonite on Mar. 23, 2011, incorporated by reference herein, may also be used in the invention.

Yet another technique that may be used in the invention is to use a digital light processor (DLP) to move the light. A DLP is a two-dimensional array of very tiny mirrors built using MEMS technology. Each minor is essentially a pixel. If the DLP is placed on a spherical curved surface, or the illumination source is diverging as it is reflected off of the DLP, then each minor will send a beam of light in a slightly different direction. Thus, if one minor is activated to reflect in a forward direction, referring to it as a 1 state, then even though all of the mirrors will be illuminated by a laser light, for example, only one minor will be in the 1 state and therefore will send a beam of light in the motion direction of the vehicle. Since the direction of that beam of light is known or can be readily determined, any reflection that can be received even from a simple single pixel receiver will enable information from the reflected object to be derived. For example, the range/distance and velocity of that object can be determined by the techniques described elsewhere herein. By alternately changing different mirrors from a 0 state to a 1 state, the field of view in front of the vehicle can be mapped using a single pixel receiver. This is a very inexpensive method of obtaining the desired results. For those mirrors in the 0 state, the light is sent in a direction which is not in the field of view of the single pixel receiver.

Lidar and DLP, a multifaceted mirror, etc., are all possibilities in the invention. Information about such techniques is disclosed in “Texas Instruments Announces New DLP(R) Pico™ Chipset Enabling Mobile Devices With Stunning Images From the Thinnest, Smallest Optical Engine Yet”, prnewswire.com, Feb. 15, 2010, incorporated by reference herein.

Referring back to FIG. 3, the processor 14 may also receive input from one or more radar systems 24. In such an embodiment, the data provided by the cameras 16 is used to obtain information about where an exterior object is, what an exterior object is and/or whether the exterior object it is likely to impact the host vehicle 10 (based on distance and motion). Data from the cameras 16 can also be analyzed by the processor 14 to determine possible velocity, while information from the radar (or lidar) system 24 determines the actual velocity relative to the host vehicle 10. Radar system 24 provides information about how fast the exterior object is moving, not where it is. Multiple radars are now used to crudely monitor various areas but at any significant distance from the vehicle the radar beam gets large.

Processor 14 may also apply various forms of pattern recognition, as explained in detail in the '770 application. For example, if the processor 14 is configured to recognize what the object is and then obtain the object's size from a look up table in a database 26, it can then determine its distance and velocity of approach. The processor 14 can also function to recognize an object on the approaching vehicle 12 and knowing its size, use its change in size to determine its approach velocity. Database 26 may be formed together with database 18, or as separate units.

The above discussion has concentrated on automobile occupant sensing but the teachings, with some modifications, are applicable to monitoring of other vehicles including railroad cars, truck trailers and cargo containers.

Although several preferred embodiments are illustrated and described above, there are possible combinations using other signals and sensors for the components and different forms of the neural network implementation or different pattern recognition technologies that perform the same functions which can be utilized in accordance with the invention. Also, although the neural network and modular neural networks have been described as an example of one means of pattern recognition, other pattern recognition means exist and still others are being developed which can be used to identify potential component failures by comparing the operation of a component over time with patterns characteristic of normal and abnormal component operation. In addition, with the pattern recognition system described above, the input data to the system may be data which has been pre-processed rather than the raw signal data either through a process called “feature extraction” or by various mathematical transformations. Also, any of the apparatus and methods disclosed herein may be used for diagnosing the state of operation or a plurality of discrete components.

Although several preferred embodiments are illustrated and described above, there are possible combinations using other geometries, sensors, materials and different dimensions for the components that perform the same functions. At least one of the inventions disclosed herein is not limited to the above embodiments and should be determined by the following claims. There are also numerous additional applications in addition to those described above. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

I claim:

1. A method for monitoring an area surrounding a host vehicle or objects external of the host vehicle during movement of the host vehicle under control of an occupant in the host vehicle, the host vehicle having a frame defining a compartment that accommodates the occupant of the host vehicle who is able to guide movement of the host vehicle when present in the compartment, the method comprising:
projecting light into an area of interest external to the host vehicle from at least one light source on the host vehicle;
detecting reflected light at at least one camera arranged on the host vehicle at a position different than the position of the at least one light source and at a position from which light reflected from any objects in the area of interest in the exterior of the host vehicle is received;
analyzing the reflected light relative to the projected light to obtain information about a distance between the host vehicle and objects located in the area of interest and motion of the objects located in the area of interest; and
causing an action on the vehicle based on the obtained information about the distance and motion.

2. The method of claim 1, wherein the step of projecting light into the area of interest comprises projecting structured light into the area of interest, rays of light forming the structured light originating from the at least one light source, the structured light being a pattern of light including a plurality of light areas and at least one dark area alongside one another.

3. The method of claim 1, wherein the step of projecting light into the area of interest comprises projecting light from a plurality of light sources, the at least one camera being positioned between the light sources, the step of analyzing the reflected light to obtain information comprising determining the distance between the host vehicle and the object in an image obtained by the at least one camera based on spacing of reflected light from the plurality of light sources.

4. The method of claim 3, wherein the plurality of light sources comprises two light sources that each projects a dot of light.

5. The method of claim 4, wherein the plurality of light sources comprise two light sources that project light beams parallel to one another.

6. The method of claim 4, wherein the plurality of light sources comprise two light sources that project light beams at an angle to one another.

7. The method of claim 1, wherein the analyzing step comprises:
inputting an image derived from the reflected light detected by the at least one camera into a processor configured to draw a virtual box around a portion of an object in the image; and
monitoring movement edges of the box that are indicative of a direction of movement of the object.

8. The method of claim 1, wherein the analyzing step comprises:
inputting an image derived from the reflected light detected by the at least one camera into a processor configured to draw virtual horizontal and vertical edges around a portion of an object in the image; and
monitoring movement of the virtual horizontal and vertical of the box that are indicative of a direction of movement of the object.

9. The method of claim 1, wherein the analyzing step comprises:
inputting an image derived from the reflected light detected by the at least one camera into a processor;
providing the processor with map data about roads in the image; and
deriving the distance between the host vehicle and an object in the image based on the map data.

10. The method of claim 1, wherein the at least one camera is configured to measure an angle of light received at each pixel, the step of analyzing the reflected light to obtain information comprising deriving the distance between the host vehicle and an object in an image obtained by the at least one camera based on the angle of light received at each pixel.

11. The method of claim 1, wherein the step of analyzing the reflected light to obtain information comprises analyzing the reflected light to recognize an object in an image obtained by the at least one camera, correlating the recognition of the object into information about a size of the object, and monitoring change in size of the object by analyzing reflected light obtained at a subsequent time to derive information about motion of the object.

12. The method of claim 1, further comprising adjusting for motion of the at least one camera by obtaining inertial measurements of the vehicle by means of an inertial measurement unit positioned on the vehicle and deriving motion of the at least one camera based on inertial measurements by the inertial measurement unit and a known positioning relationship between the inertial measurement unit and the at least one camera.

13. The method of claim 1, wherein the at least one camera includes an aspheric or fish-eye lens.
